(19) United States
(12) Patent Application Publication
(10) Pub. No.: US 2003/0107286 A1
(43) Pub. Date: Jun. 12, 2003

(54) Single-phase two-speed electric motor with enhanced coil-winding system

(76) Inventors: Adilson Carlos Machado, Centro-Guaramirim-Santa Catarina (BR); Joao Envangelista Pacheco, Vila Mariana-Sao Paulo (BR)

Correspondence Address: CANTOR COLBURN, LLP, 55 GRIFFIN ROAD SOUTH, BLOOMFIELD, CT, 06002

(21) Appl. No.: 10/166,544

(22) Filed: Jun. 10, 2002

(30) Foreign Application Priority Data
Dec. 6, 2001 (BR) PI 0106545-9

(51) Int. Cl. H02K 1/00; H02K 3/00

(52) U.S. Cl. 310/179; 310/184

(57) ABSTRACT

A single phase two speed electric motor including a coil-winding system composed by only two distinct statoric coil-windings, assembled upon a single magnetic-plates nucleus, for utilization in electric motors supplied by single-phase power; the motor is of the permanent capacitor type, operating in two speeds (low and high) and in both rotation directions (clockwise and counterclockwise), where the coil-windings alternate as principal and auxiliary, that which is in series with the capacitor being defined as the auxiliary one.

The present report refers to an Invention Patent of a single-phase two-speed electric motor, which incorporates an enhanced coil-winding system.

In this way, the present patent application bears a coil-winding system for electric motors specially designed and developed to assure greater practicality and which renders many advantages, either in its operation as well as in its manufacturing.

Presently, every single-phase electric motor featuring two speeds bears more than two statoric coil-windings, these being defined by specific coil-windings for each desired rotation regime.

For a better understanding and comprehension of the hereby-claimed single-phase two-speed electric motor with enhanced coil-winding system's constitution illustrative drawings are presented attached herewith, where:

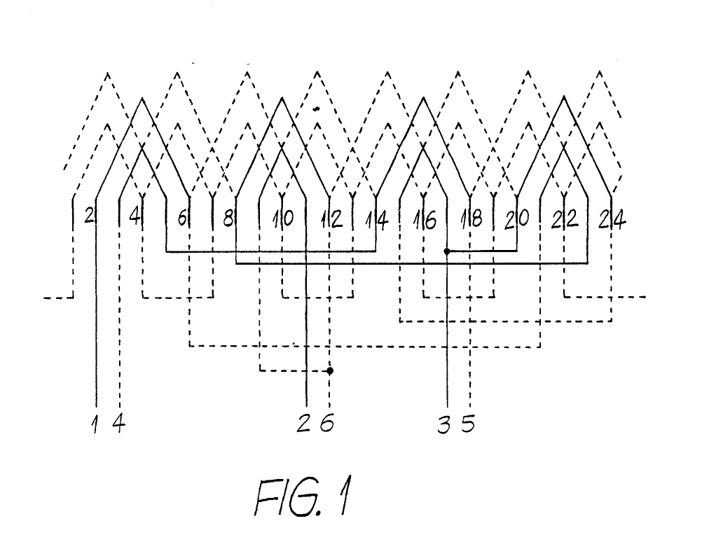

FIG. 1 shows a two-speed statoric coil scheme (example of an 8 and 4 pole stator with 24 slots);

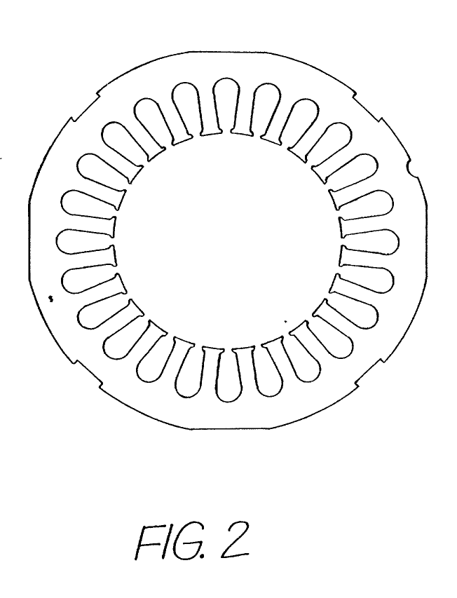

FIG. 2 shows a 24-slot stator example;

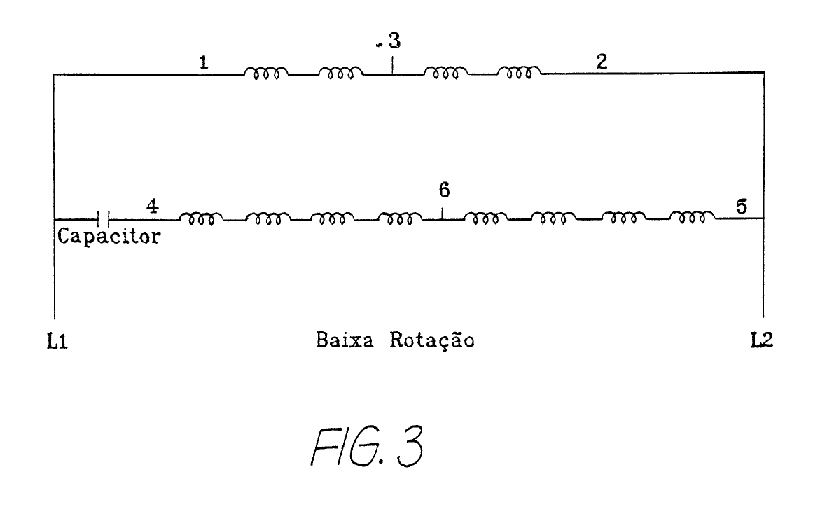

FIG. 3 shows the connection-scheme for low rotation operation regimes (in accordance to example in FIG. 1); and

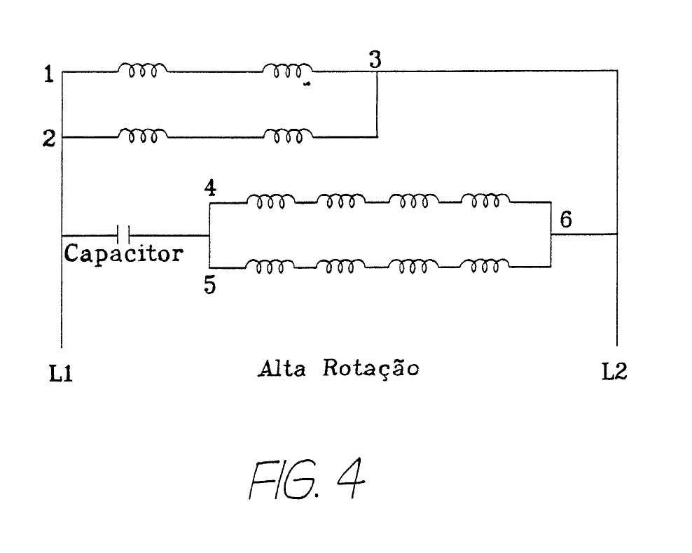

FIG. 4 shows the connection-scheme for high rotation regimes (in accordance to example in FIG. 1).

As illustrated by the figures mentioned above, the single-phase two-speed electric motor with enhanced winding system, object of the present patent application, is essentially characterized by being constituted of a special winding system composed by two distinct statoric coil-windings, assembled upon a single magnetic-plates nucleus, for utilization in electric motors supplied by single-phase power.

The motor is of the permanent capacitor type, operating in two speeds (low and high) and in both rotation directions (clockwise and counterclockwise), where the coil-windings alternate as principal and auxiliary, that which is in series with the capacitor being defined as the auxiliary one.

The speeds relation is 1/2, or else, one is twice the other, these being defined by the number of magnetic poles of the statoric coil-winding, which may be of 4/2, 8/4, 12/6 poles, etc., as the rotation direction is inversely proportional to the number of poles.

One of the coil-windings has twice the bobbins groups of the other, such number being defined by the desired number of poles. As for the bobbin numbers of each group, it will depend on the stator's number of slots.

In the example shown in FIG. 1, we have a set of an 8/4 pole motor's coil-winding placed in a 24-slot stator, where one of the coil-windings is formed by 4 groups (full line) and the other is formed by 8 groups (dotted line), both with two bobbins in each group.

The quantity of spires in each bobbin, the wire's gauge, the number of slots and the stator's size will depend on the power and polarity of the projected motor.

The main advantage for this special coil-winding system in relation to the state-of the-art is the possibility of obtaining a two-speed motor (where one speed is twice the other) with a lesser volume of active material (plates and copper) for a given desired power and speed relation.

As for its operation, when the motor is started according to FIG. 3, it will work at its low speed, being the rotation directions inverted when the supply in L₁ is changed from cable No. 1 to cable No. 4.

When the motor is started according to FIG. 4, it will work at its high speed, being the rotation directions inverted when the supply in L₁ is changed from cables Nos. 1-2 to cables Nos. 4-5.

Thus, the present descriptive report discusses a new concept for electric motors' coil-winding systems, presenting innumerous differences upon the conventional systems available in the market as evidenced by the analysis presented and by the figures attached, besides a completely different construction and technical functional characteristics diverse to those pertaining to the state-of-the-art. By the advantages offered and yet by assuming characteristics really innovative, which fulfil every novelty and originality requirements for the gender, the present single-phase two-speed electric motor with enhanced coil-winding system, reunites the necessary conditions to deserve the herein required Privilege under the nature of a invention patent.

1. “SINGLE-PHASE TWO SPEED ELECTRIC MOTOR WITH ENHANCED COIL-WINDING SYSTEM”, comprising a coil-winding system essentially characterized by the allowance of two speeds, one being twice the other.

2. “SINGLE-PHASE TWO SPEED ELECTRIC MOTOR WITH ENHANCED COIL-WINDING SYSTEM”, according to claim 1, characterized by the fact that the enhanced coil-winding system allows the rotation of referred electric motor to alternate from low to high and yet to alternate the rotation direction (from clockwise to counterclockwise) at both speeds.

3. “SINGLE-PHASE TWO SPEED ELECTRIC MOTOR WITH ENHANCED COIL-WINDING SYSTEM”, according to claims 1 and 2, characterized by bearing only two distinct coil-windings which alternate in the function of principal and auxiliary whenever the rotation direction is inverted (clockwise and counterclockwise) at any of its operation speeds, that in series with the capacitor being defined as the auxiliary one.

4. “SINGLE-PHASE TWO SPEED ELECTRIC MOTOR WITH ENHANCED COIL-WINDING SYSTEM”, according to claims 1, 2 and 3, characterized by the fact that the referred coil-windings present different bobbins groups.

5. “SINGLE-PHASE TWO SPEED ELECTRIC MOTOR WITH ENHANCED COIL-WINDING SYSTEM”, according to claims 1, 2 and 3, characterized by the fact that the referred coil-winding system presents two distinct polarities, one being twice the other, as for example: 4/2, 8/4, 12/6 poles, etc.
